(19) United States
(12) Patent Application Publication
(10) Pub. No.: US 2013/0290199 A1
(43) Pub. Date: Oct. 31, 2013

(54) Monitoring and Aiding User Compliance with Vehicle Use Agreements

(71) Applicants: Esteban Camacho, Belleville, MI (US); Dexter C. Lowe, Sterling Heights, MI (US); Shpetim S. Veliu, Livonia, MI (US); David A. Lohmeier, Clarkston, MI (US)

(72) Inventors: Esteban Camacho, Belleville, MI (US); Dexter C. Lowe, Sterling Heights, MI (US); Shpetim S. Veliu, Livonia, MI (US); David A. Lohmeier, Clarkston, MI (US)

(73) Assignee: GENERAL MOTORS LLC, Detroit, MI (US)

(21) Appl. No.: 13/460,032

(22) Filed: Apr. 30, 2012

(51) Int. Cl. G06Q 99/00

(52) U.S. Cl. 705/317

(57) ABSTRACT

A method is described for using a telematics system to monitor compliance with a vehicle use agreement. Monitoring is facilitated by vehicle sensors and GPS components. The method includes receiving information from onboard vehicle sensors, applying the vehicle data received from onboard vehicle sensors with pre-stored information pertaining to the vehicle use agreement, and determining whether the information acquired from onboard vehicle sensors indicates potential non-compliance with the use agreement. Information pertaining to the use agreement is stored in an onboard telematics unit or in a database maintained by a Telematics Service Provider. Upon identification of potential non-compliance with the vehicle use agreement, the telematics system notifies an interested party. Furthermore, interested parties are provided with options for addressing the detected potential non-compliance with the vehicle use agreement.

### TECHNOLOGY FIELD

The present disclosure relates generally to telematics systems and more specifically to using telematics systems within multi-user (e.g., rental) vehicles.

### BACKGROUND

Telematics units within mobile vehicles provide subscribers with connectivity to a telematics service provider (TSP). The TSP provides subscribers with an array of services ranging from emergency call handling to stolen vehicle recovery and diagnostics monitoring. Telematics units are provisioned and activated at a point of sale when a subscriber purchases a telematics-equipped vehicle. Upon activation, the telematics unit provides a subscriber with a wide variety of telematics services.

Among other features, telematics units enable TSPs to pinpoint the location of telematics-equipped vehicles. Furthermore, once a vehicle has been located, TSPs are able to use road maps and other information stored on databases to ascertain the optimal route between a current location and a desired destination. TSPs can transmit route information through the telematics unit to the driver and thereby provide the driver with turn-by-turn directions. The navigational capabilities of telematics systems minimize driving times by reducing the risk of wrong turns and improving driver performance.

Novel methods of vehicle time sharing have developed in recent years in response to increased opportunities for monetizing the idle capacity of unused vehicles. Automobile rental services have become increasingly popular in locations where the costs of owning and storing a vehicle are high relative to potential owners' available cash flows and where potential owners are likely to use vehicles for only a small percentage of the total available time. Vehicle time sharing business models have become particularly successful in urban areas and nearby large universities. Meanwhile, more traditional automobile rental business models, such as those that maintain large vehicle fleets in the vicinity of airports to cater to business travelers and vacationers, have remained successful.

Automobile rental services and other automobile owners who intend to rent or loan their automobiles may choose to maintain accounts with TSPs in order to preserve the functionality of telematics units for their customers and for themselves. However, TSPs have not provided telematics systems with specific functionality for the vehicle rental market. In the context of automobile rentals, it is highly advantageous for the vehicle owner to have knowledge of the user's specific circumstances of time and place. Where unforeseen circumstances have a substantial impact on the vehicle user's plans, the owner and future users can realize significant benefits from having access to up-to-date information concerning the current and future whereabouts of a rented vehicle. Furthermore, current users could benefit from receiving information relevant to their compliance or non-compliance with the terms and conditions of the use agreement entered into with the vehicle's owner.

### SUMMARY OF THE INVENTION

in the case of a multi-user (e.g., rental) vehicle equipped with a telematics system, the TSP ascertains vehicle data from the vehicle's telematics unit that would not be accessible to the vehicle's owner, and in some cases also unavailable to the vehicle's current occupant, without a telematics unit. Prior to releasing a vehicle to a potential user pursuant to a loan or rental arrangement, the user agrees to terms and conditions governing the use of the vehicle during the loan/rental period. For example, the user may agree to return the vehicle to the owner at a specified time and place. Furthermore, the user may agree to pay a fine if the vehicle is returned late or if some unauthorized use of the vehicle, such as exceeding a mileage limit, is made. Vehicle data provided by the telematics unit to the vehicle owner and current user increases compliance with rental terms and conditions, enables real-time monitoring of use agreement compliance, and enables vehicle owners and future users to react to a current user's deviation from pre-established terms and conditions.

Implementations of the present invention contemplate harnessing services conventionally provided by TSPs to present vehicle owners and users with real time vehicle data concerning a vehicle's current location and condition as well as compliance or non-compliance with terms and conditions of a use agreement. TSPs identify the location of a vehicle through the provision of Global Positioning System (GPS) navigation services. Moreover, by providing turn-by-turn directions, TSPs provide exact driving directions instructing the user how to reach a specified location. For example, the TSP can instruct the user how to return to the location where the multi-user (e.g., rental) vehicle is to be surrendered to the vehicle's owner. Sensors connected to a vehicle's telematics system enable current diagnostics data to be communicated from a vehicle to the TSP. The TSP monitors the vehicle's sensors via the telematics unit to observe and/or record deviations from agreed terms for use of the vehicle.

One implementation incorporates a method for monitoring compliance with terms and conditions of a vehicle use agreement. The method includes receiving vehicle data from at least one of a vehicle sensor and a GPS chipset. Next received data is applied to pre-stored data pertaining to the terms and conditions of a vehicle use agreement. The application of the received data to the vehicle use agreement enables identifying a potential violation of terms and/or conditions of the vehicle use agreement. In such instances, a notification is issued to at least one of a current driver, a vehicle owner, and a subsequent user of the potential violation via an in-vehicle telematics communication channel.

Another implementation incorporates a method for modifying the terms and conditions of a vehicle use agreement. The method includes receiving vehicle data pertaining to non-compliance, by a current user of a vehicle, with a first vehicle use agreement. The method further includes determining whether a failure, by the current user, to comply with the first vehicle use agreement creates an opportunity for a subsequent user to modify terms and conditions of a second vehicle use agreement. If non-compliance, by the current user, with the first use agreement creates the opportunity for modifying the second vehicle use agreement, then further steps are carried out including: notifying the subsequent user of the non-compliance and requesting the subsequent user to choose from possible modifications of the second use agreement, receiving a response by the subsequent user indicating a modification to second vehicle use agreement, and modifying the second use agreement pursuant to the response by the subsequent user.

A third implementation incorporates a method for determining an earliest estimated time when a multi-user (e.g., rental) vehicle will be able reach a return destination. The method includes receiving a request fix directions to the return destination. The current location of the vehicle is determined using a GPS chipset. Appropriate turn-by-turn directions are determined based upon the current location and the destination location. The expected travel time is determined based upon at least the route, corresponding to the turn-by-turn directions, from the current vehicle location to the return destination.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic diagram of an operating environment for a mobile vehicle communication system usable in implementations of the described principles;

FIG. 2 is a flow chart summarizing steps for an exemplary method for monitoring compliance with the terms and conditions of a vehicle use agreement;

FIG. 3 is a flow chart summarizing steps for an exemplary method for modifying terms and conditions of use agreements that govern future vehicle rentals based on non-compliance with the terms and conditions of use agreements governing current or past rentals; and

FIG. 4 is a flow chart summarizing steps for an exemplary method for determining the expected time of return for a rented vehicle and notifying interested parties of late returns.

### DESCRIPTION OF THE DRAWINGS

Before discussing the details of illustrative examples and the environment wherein such example may be used, a brief overview of an exemplary telematics system is given to guide the reader. En general terms, not intended to limit the claims, the illustrative examples are directed to a system and a method for providing real time updates concerning the geospatial location and other conditions of a rented vehicle.

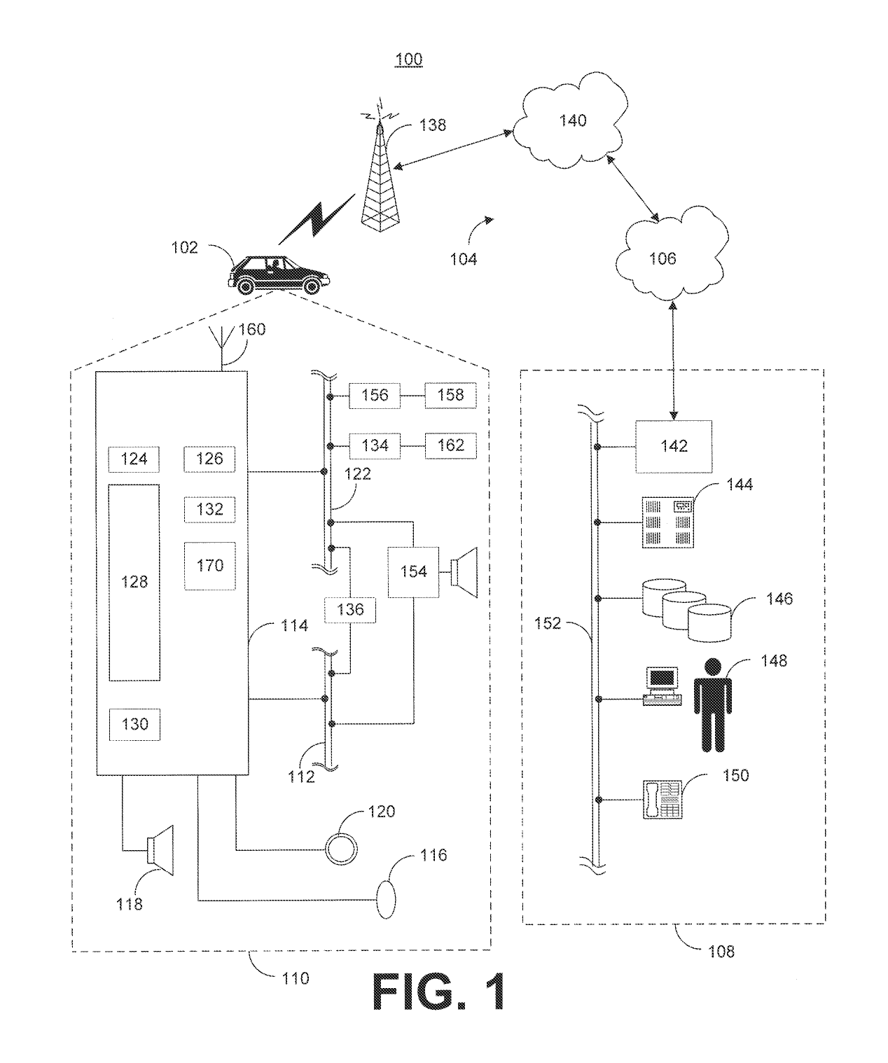

FIG. 1 schematically depicts an exemplary environment for carrying out the illustrative examples. It will be appreciated that the described environment is an example, and does not imply any limitation regarding the use of other environments to practice the examples. With reference to FIG. 1 there is shown an example of a communication system 100 that may be used with the present method and system and generally includes a vehicle 102, a wireless carrier system 104, a land network 106 and a call center 108. It should be appreciated that the overall architecture, setup and operation, as well as the individual components of a system such as that shown in FIG. 1 are generally known in the art. Thus, the following paragraphs provide a brief overview of one such exemplary information system 100; however, other systems could employ the present method as well.

Vehicle 102 is a mobile vehicle such as a motorcycle, car, truck, recreational vehicle (RV), boat, plane, etc., and is equipped with suitable hardware and software that enables it to communicate over system 100. The vehicle 102 is, in particular, a vehicle rented for periods of time by its owner to temporary users. Additionally, vehicle hardware 110 shown generally in FIG. 1 includes: a telematics unit 114, a microphone 116, a speaker 118 and buttons and/or controls 120 connected to the telematics unit 114. Operatively coupled to the telematics unit 114 is a network connection or vehicle bus 122. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few.

The telematics unit 114 is an onboard device providing a variety of services through its communication with the call center 108, and generally includes an electronic processing device 128, one or more types of electronic memory 130, a cellular chipset/component 124, a wireless modem 126, a dual antenna 160 and a navigation unit containing a GPS chipset/component 132. In one example, the wireless modem 126 comprises, and is carried out in the form of, a computer program and/or set of software routines executing within the electronic processing device 128. The cellular chipset/component 124 and the wireless modem 126 may be called the network access device (NAD) of the telematics unit 114. The NAD further includes a short-range wireless unit 170 capable of communicating with a user's mobile device such as a cellular phone, tablet computer, PDA, or the like, over a short-range wireless protocol. For example, in one implementation, the short-range wireless unit 170 is a Bluetooth unit with an RF transceiver that communicates with a user's mobile device using Bluetooth protocol.

The telematics unit 114 provides a variety of services for subscribers. Examples of such services include: turn-by-turn directions and other navigation-related services provided in conjunction with the GPS based chipset/component 132; airbag deployment notification and other emergency or roadside assistance-related services provided in connection with various crash and or collision sensor interface modules 156 and sensors 158 located throughout the vehicle.

GPS navigation services are implemented based on the geographic position data of the vehicle provided by the UPS based chipset/component 132. A user of the telematics unit enters a destination using inputs corresponding to the GPS component, and a route to a destination is calculated based on the destination address and a current position of the vehicle determined at approximately the time of route calculation. Furthermore, the telematics system may provide the approximate expected travel time from a current location of the vehicle and the destination location at approximately the time of route calculation. Turn-by-turn (TBT) directions may further be provided on a display screen corresponding to the GPS component and/or through vocal directions provided through a vehicle audio component 154. It will be appreciated that the calculation-related processing may occur at the telematics unit or may occur at a call center 108.

Infotainment-related services are provided by the TSP wherein music, Web pages, movies, television programs, video games and/or other content is downloaded to an infotainment center 136 operatively connected to the telematics unit 114 via a vehicle bus 122 and an audio bus 112. In one example, downloaded content is stored for current or later playback.

Again, the above is by no means an exhaustive list of all the capabilities of telematics unit 114, as should be appreciated by those skilled in the art, but is simply an illustration of some of the services that the telematics unit 114 offers. The telematics unit 114 includes a number of known components in addition to those described above.

Vehicle communications use radio transmissions to establish a communications channel within the wireless carrier system 104 so that voice and/or data transmissions occur over the communications channel. Vehicle communications are enabled via the cellular chipset/component 124 for voice communications and a wireless modem 126 for data transmission.

To enable successful data transmission over the communications channel, wireless modem 126 applies some form of encoding or modulation to convert the digital data so that it can communicate through a vocoder or speech codec incorporated in the cellular chipset/component 124. Any suitable encoding or modulation technique that provides an acceptable data rate and bit error can be used with the present method. Dual mode antenna 160 services the GPS chipset/component and the cellular chipset/component.

The microphone 116 provides the driver or other vehicle occupant with a means for inputting verbal or other auditory commands, and can be equipped with an embedded voice processing unit utilizing a human/machine interface (HMI) technology known in the art. Conversely, the speaker 118 provides verbal output to the vehicle occupants and can be either a stand-alone speaker specifically dedicated for use with the telematics unit 114 or can be part of a vehicle audio component 154. In either event, the microphone 116 and the speaker 118 enable vehicle hardware 110 and the call center 108 to communicate with the occupants through audible speech.

The vehicle hardware also includes one or more buttons or controls 120 configured to enable a vehicle occupant to activate or engage one or more of the vehicle hardware components 110. For example, one of the buttons 120 is an electronic push button that, when pressed, initiates voice communication with a call center 108 (whether it be a live advisor 148 or an automated call response system). In another example, one of the buttons 120, when pushed, initiates emergency services.

The audio component 154 is operatively connected to the vehicle bus 122 and the audio bus 112. The audio component 154 receives analog data, rendering it as sound, via the audio bus 112. Digital data is received via the vehicle bus 122. The audio component 154 provides AM and FM radio, CD, DVD, and multimedia functionality independent of the infotainment center 136. The audio component 154 contains a speaker system, or alternatively utilizes the speaker 118 via arbitration on vehicle bus 122 and/or audio bus 112.

The vehicle crash and/or collision detection sensor interface 156 is operatively connected to the vehicle bus 122. The crash sensors 158 provide data to the telematics unit 114 via the crash and/or collision detection sensor interface 156 regarding the severity of a vehicle collision, such as the angle of impact and the amount of force sustained.

Vehicle sensors 162, connected to various sensor interface modules 134 are operatively connected to the vehicle bus 122. Example vehicle sensors include but are not limited to gyroscopes, accelerometers, magnetometers, emission detection and/or control sensors, and the like. Example sensor interface modules 134 include power train control, climate control, and body control, to name but a few.

Wireless carrier system 104 is preferably a cellular telephone system or any other suitable wireless system that transmits signals between the vehicle hardware 110 and land network 106. According to an example, the wireless carrier system 104 includes one or more cell towers 138, base stations and/or mobile switching centers (MSCs) 140, as well as any other networking components required to connect the wireless system 104 with land network 106. A component in the mobile switching center may include a remote data server.

As appreciated by those skilled in the art, various cell tower/base station/MSC arrangements are possible and could be used with the wireless system 104 (also referred to as the “cellular network” herein). For example, a base station and a cell tower could be co-located at the same site or they could be remotely located, and a single base station could be coupled to various cell towers or various base stations could be coupled with a single MSC, to name but a few of the possible arrangements. Preferably, a speech codec or vocoder is incorporated in one or more of the base stations, but depending on the particular architecture of the wireless network, it could be incorporated within a Mobile Switching Center or some other network components as well.

The land network 106 is, for example, a conventional land-based telecommunications network connected to one or more landline telephones and connecting wireless carrier network 104 to call center 108. For example, land network 106 includes a public switched telephone network (PSTN) and/or an Internet protocol (IP) network, as is appreciated by those skilled in the art. Of course, one or more segments of the land network 106 are implemented in the form of a standard wired network, a fiber or other optical network, a cable network, other wireless networks such as wireless local networks (WLANs) or networks providing broadband wireless access (BWA), or any combination thereof.

Call Center (OCC) 108 is designed to provide the vehicle hardware 110 with a number of different system back-end functions and, according to the example shown here, generally includes one or more switches 142, servers 144, databases 146, live advisors 148, as well as a variety of other telecommunication and computer equipment 150 that is known to those skilled in the art. These various call center components are preferably coupled to one another via a network connection or bus 152, such as the one previously described in connection with the vehicle hardware lift. Switch 142, which can be a private branch exchange (PBX) switch, routes incoming signals so that voice transmissions are usually sent to either the live advisor 148 or an automated response system, and data transmissions are passed on to a modem or other piece of telecommunication and computer equipment 150 for demodulation and further signal processing.

The telecommunication and computer equipment 150 includes a modem that preferably includes an encoder, as previously explained, and can be connected to various devices such as application servers 144 and databases 146. For example, the databases 146 could be designed to store subscriber profile records, subscriber behavioral patterns, or any other pertinent subscriber information. Although the illustrated example has been described as it would be used in conjunction with a manned call center 108, it will be appreciated that the call center 108 can be any central or remote facility, maimed or unmanned, mobile or fixed, to or from which it is desirable to exchange voice and data.

Computer programs and other software routines that run on the electronic processing device 128 receive data from the vehicle sensors 162 and the crash sensors 158 through the sensor interface modules 134 and the crash and/or collision detection, sensor interface 156 respectively. These programs and software routines further receive data pertaining to the geographic location of the vehicle from the GPS based chipset/component 132. The computer programs and software routines monitor the received data and apply the received data to conditions for triggering an exception event (e.g., a potential violation by the current user of a use agreement for the vehicle). For example, the computer programs and software routines detect, based upon applying the received vehicle data, that the vehicle has travelled more than a threshold distance since the occurrence of a particular event or that the vehicle has exceeded a threshold speed. The computer programs and software routines also determine that the vehicle has traveled more than a threshold distance from a specified location or that the vehicle has not traveled to a specified location within a certain period of time. Upon determining that a certain condition is met for triggering an exception event, the computer programs and software routines determine whether it is appropriate to issue a notification to an occupant of the vehicle. If it is appropriate to issue such a notification, the telematics unit 114 issues the notification, for example, via the speaker 118, via a display screen corresponding to the GPS-based component 132, or via some other medium. The computer programs and software routines also solicit a response from the occupant if a response is necessary. If appropriate, the computer programs and software routines also transmit information to the OCC 108 where it is routed by the switch 142. Depending, on the nature of the information which is transmitted to the OCC 108, the information may be processed by one or more of: a live advisor 148, an automated response system, and a piece of telecommunication and computer equipment 150.

By way of example, the databases 146 maintain information pertaining to terms and conditions of an agreement governing a loan or rental of a vehicle equipped with a telematics unit. The OCC 108, either through live advisors 148 or through telecommunication and computer equipment 150, communicates with the owner of a vehicle equipped with a telematics unit who elects to rent or loan the vehicle to potential users. The vehicle owner has access to the databases 146 and directly updates the information stored on the databases 146 and pertaining to the loaning or rental of vehicles of the vehicle owner. Alternatively, the databases 146 maintained at the OCC 108 acquire information from a database maintained on other servers if the vehicle owner does not have direct access to the databases 146 maintained at the OCC. Database entries including the terms and conditions governing loan or rental of vehicles of the owner cover all rentals made by that owner, or alternatively, the database entries are applicable only to a single use by a non owner.

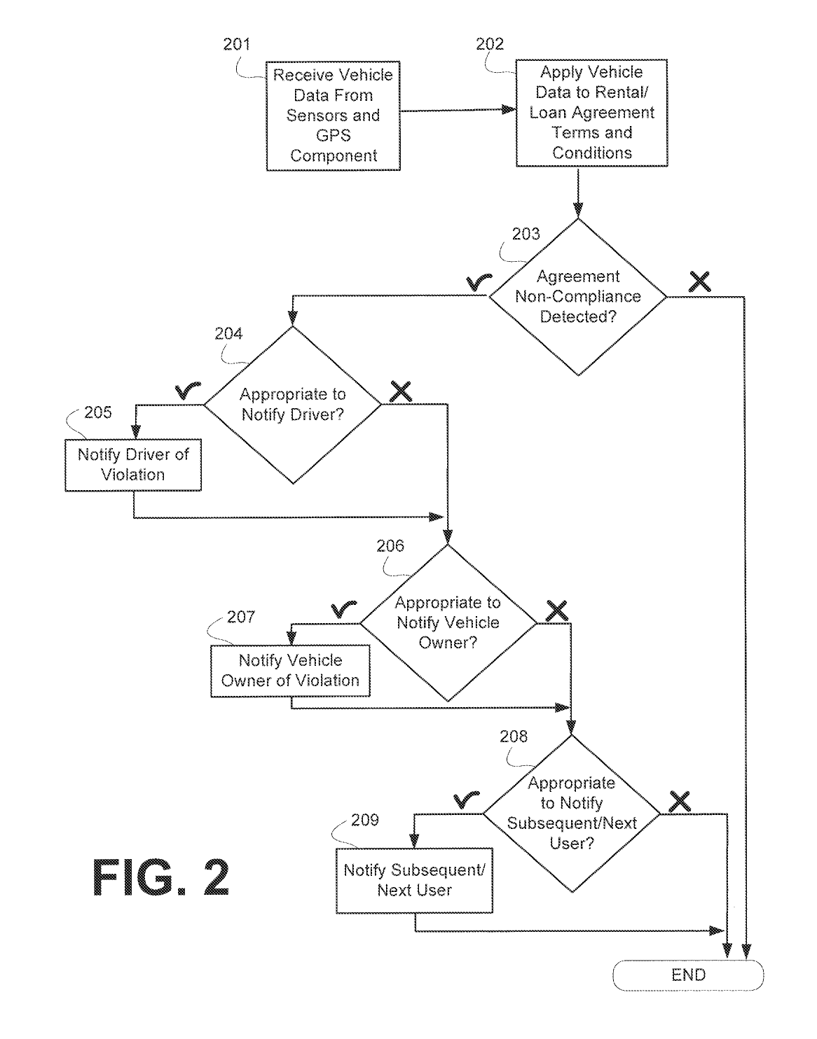

FIG. 2 depicts summarized steps associated with an exemplary method for monitoring and aiding compliance with terms and conditions governing use (e.g., loan, rental, etc.) of a vehicle by a non-owner and notifying interested parties of a deviation from a term or condition specified in the agreement. Interested parties include, for example, an owner of the vehicle and may also include a next scheduled user of the vehicle. With reference to FIG. 2, during step 201, the telematics unit 114 receives vehicle data originating from the vehicle sensors 162, crash the sensors 158, and the GPS component 132. The vehicle data includes the current geospatial location of the vehicle, current fuel level, current mileage, vehicle temperature, maximum engine RPM attained, and other vehicle diagnostics.

Thereafter, during step 202, the telematics unit 114 applies the vehicle data received during step 201 to vehicle use agreement data including, for example, the terms and conditions governing rental/loan of the vehicle by the current user. Information pertaining to the terms and conditions governing the vehicle rental/loan are stored in the electronic memory 130 or the databases 146 maintained at the OCC 108. Thereafter, at step 203, if the software routines executed by the electronic processing device 128 of the telematics unit 114 identify, based upon the application of the vehicle data to the agreement during step 202, a violation (non-compliance) of any of the terms and conditions of the vehicle use (e.g., loan/rental) agreement, then control passes to step 204. For example, during steps 202 and 203, the telematics unit 114 can apply a GPS location, an odometer (current mileage) or a speedometer (sensed maximum) reading to an agreed maximum, range or geospatial area to determine whether the vehicle has exceeded a maximum permitted total travel distance or speed, or the driver has traveled to a geospatial location forbidden by the use agreement. The telematics unit 114 also incorporates vehicle return information, such as the designated vehicle return location or time, to determine whether the driver must exceed the maximum permitted total travel distance to return the vehicle to the designated vehicle return location in the vehicle use agreement, or the driver is in a current location that will prevent returning the vehicle to a mandated return location by a mandated time of return. If no violation is detected during step 203, then control passes from step 203 to the End.

During step 204, if software routines running on the electronic processing device 128 determine that the driver is to be notified of the particular non-compliant activity or condition, then control passes to step 205. During step 205, a notification of non-compliance is issued to the driver of the vehicle through, for example, an audio message played via speaker 118 or vehicle audio component 154 or through a visually displayed message. Control then passes from step 205 to step 206. If, during step 204, the driver is not to be notified, then control passes from step 204 directly to step 206.

During step 206, if software routines running on the electronic processing device 128 determine that the vehicle owner is to be notified of the particular non-compliant activity or condition, then control passes to step 207. During step 207, the telematics unit 114, by way of example, uses the cellular chipset/component 124 and modem 126 to transfer information concerning non-compliance with the vehicle use agreement via the dual-mode antenna 160 to the vehicle owner. Control then passes from step 207 to step 208. If during step 206, the owner of the vehicle is not to be notified of the violation, then control passes from step 206 directly to step 208.

During step 208, if software routines running on the electronic processing device 128 determine that a subsequent (e.g., next scheduled) user is to be notified of the particular non-compliant activity or condition (e.g., a late vehicle return), then control passes to step 209. During step 209, the telematics unit 114, by way of example, uses the cellular chipset/component 124 and modem 126 to transfer information concerning any non-compliance via the dual-mode antenna 160 to the subsequent user. Control then passes from step 209 to the End. If during step 208, the subsequent user is not to be notified, then control passes directly from step 208 to the End.

Alternatively, the OCC 108 receives data from the telematics unit 114 that was previously acquired by the vehicle sensors 162, crash sensors 158, and GPS component 132 and possibly further data stored in the electronic memory 130. The OCC 108 then processes the vehicle data received from the telematics unit. The processing is performed by the servers 144 and includes applying (e.g., comparing and analyzing) the vehicle data received from the telematics unit with information pertaining to terms and conditions governing rental of the vehicle that is stored in the databases 146. If the processing reveals any non-compliance with the rental terms and conditions, further processing is undertaken to determine whether such non-compliance is to be communicated to any of the driver, the vehicle owner, and a subsequent user. If any such interested parties are to be notified, the telecommunication and computer equipment 150 located at the OCC 108 sends a notification to the appropriate interested person. Contact information for the appropriate interested person may be stored in the databases 146 or stored in the electronic memory 130 of the telematics unit 114.

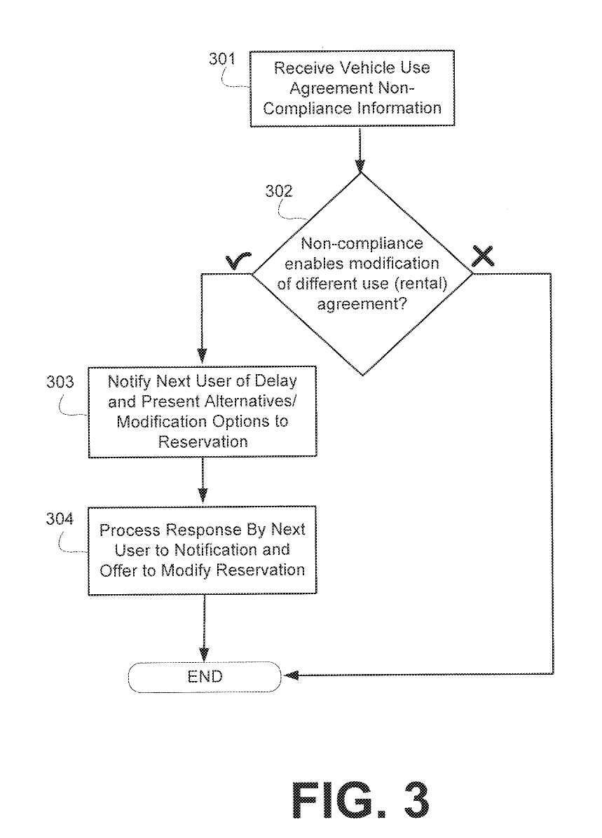

FIG. 3 depicts summarized steps associated with an exemplary method for modifying terms and conditions of a future use agreement for a particular vehicle based on an occurrence of non-compliance with terms and conditions of a previous or current use agreement for the particular vehicle. During step 301, the OCC 108 receives information pertaining to detecting an instance of non-compliance based upon vehicle data provided by the telematics unit 114, which transmits information via the dual mode antenna 160. At step 302, if the servers 144 and the computer equipment 150 determine that the detected instance of non-compliance creates an opportunity for a future user to modify the terms and conditions of a use agreement, then control passes to step 303. For example, during step 302 the telematics unit determines that a crash has occurred or that the vehicle will not be available at the pick-up time specified in a subsequent (e.g., next) user's reservation/use agreement. In such circumstances, during step 303 the OCC 108 notifies the future user of the delay and provided the option to modify his or her use agreement. Communication with the subsequent user occurs, for example, via the telecommunication and computer equipment 150 or via a live operator 148. During step 304, the OCC 108 processes a response by the next user to the notification issued by the OCC 108 during step 303. Such next user responses include, for example, a choice to modify, cancel, or maintain the terms and conditions of the current reservation. Thus, during step 304, servers 144 at the OCC 108 update (if necessary) the reservation for the next user (e.g., cancel or modify the reservation) or maintain the reservation in its current form according to the next user choice received from the next user. Control then passes from step 304 to the End. If, during step 302, the opportunity to modify the reservation (rental agreement) for the next user, then control passes from step 302 to the End.

Alternatively, the telematics unit 114 transmits all information concerning any non-compliance with terms and conditions of the use agreement to the OCC 108 and servers 144 at the OCC 108 determine whether any such non-compliance is of a type that will enable future users to modify the terms and conditions of their use agreements. Other examples allow the telematics unit 114 to contact future users directly, i.e. without going through the OCC 108. In such examples, information concerning the terms and conditions of the use agreements entered into by future users may be stored in the electronic memory 130 of the telematics unit 114 and the electronic, processing device 128 modify or retain information concerning the terms and conditions of the use agreement entered into by the future user according to a choice made by the future user.

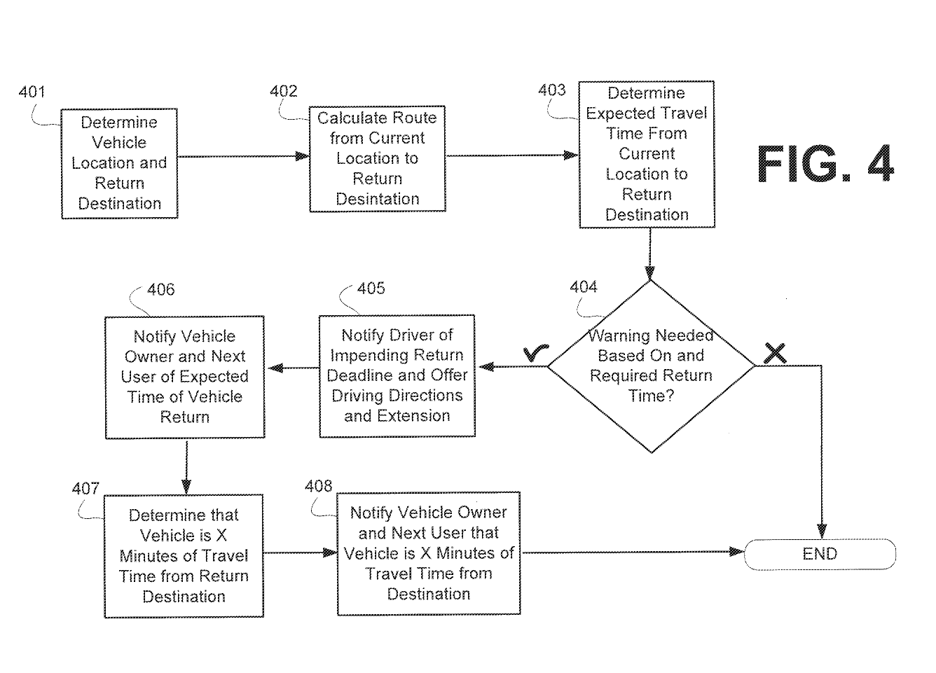

FIG. 4 summarizes exemplary steps of a method for monitoring and aiding timely return of a rented/loaned multi-user vehicle based on real time determination of a geospatial location of the vehicle. In the case of a rental car, the operation of the system (e.g., issuance of a warning message) potentially takes into consideration rental turnaround time (e.g., checking and cleaning the vehicle) and a next scheduled pickup time for a next use of the car.

During step 401, the telematics unit 114 determines a current location of the vehicle from information provided by the GPS component 132 and further determines a pre-established return destination and required return time specified by the terms and conditions of the vehicle use agreement. The return requirements for the vehicle are stored, for example, in the electronic memory 130 or in the databases 146 located at the OCC 108. During step 402, the telematics unit 114 calculates the best route from the current location to the return destination. In determining the best route from the current location to the return destination, the telematics unit receives, by way of example, information from the OCC 108, such as information concerning traffic or weather conditions. During step 403, expected travel time is determined between the current location of the vehicle and a location at which the use agreement specifies the vehicle is to be returned. The expected travel time is determined, for example, by the telematics unit 114 through either the GPS component 132 or the electronic processing unit 128, or the expected travel time is determined by the servers 144 or computer and telecommunications equipment 150 located at the OCC 108. Expected travel time potentially takes into account driving routes, traffic, weather conditions, expected delays, as well as any additional information stored in the databases 146 or the electronic memory 130. At step 404, if a warning is needed based on the expected and scheduled (per the use agreement) return times, then control passes to step 405. The determination at 404 is made by the telematics unit 114 either through the GPS component 132 or the electronic processing unit 128. Alternatively, the determination is made, at step 404 by the servers 144 or computer and telecommunications equipment 150 located at the OCC 108. With continued reference to step 404, if the estimated time at which the rented vehicle could be expected to reach the specified return location is later than a specified warning time based at least upon the vehicle return time specified in the use agreement, then control passes to step 405. If, however, a warning is not needed, then control passes from step 404 to the End.

During step 405 the driver of the rented vehicle is notified of the impending late return of the vehicle. Such notification is provided, for example, either through the speaker 118, through the vehicle audio component 154, or through a display. If the user has linked a mobile device, such as a cellular phone, tablet computer, or laptop to the telematics unit 114, the driver also receives the notification via any one or more of such mobile wireless devices. Also during step 405 the driver provided additional assistance in view of the impending late return of the vehicle. For example, during step 405 the driver is offered the choice to extend the vehicle rental period and pay the corresponding fee. Moreover, the driver receives turn-by-turn instructions for the calculated driving path that will result in returning the vehicle in the shortest estimated time period based upon the current location and the specified vehicle return location. Control then passes to step 406.

During step 406, the vehicle owner and/or the next user (e.g., renter) of the vehicle are notified of the estimated time for the vehicle. Vehicle return time is, for example, the new time that the vehicle must be returned as a result of the extension or, alternatively, the expected time of return as determined during step 404. Control then passes to step 407.

During step 407, the telematics unit 114, based on information provided from the GPS component 132, determines that the vehicle has reached a location from which is will take only a specified amount of time to reach the return destination specified by the use agreement (including no additional time if the destination is reached). In response, during step 408, the telematics unit 114 issues a notification to the vehicle owner and/or the next user that the vehicle will arrive at the return location in a specified amount of time. For example, when the vehicle reaches a point that has been determined to be 15 minutes of travel time from the return location, the telematics unit 114 issues a notification to the vehicle owner and next user via the dual antenna 160 that the vehicle will reach the return destination in 15 minutes. The specified amount of time could also be 30 minutes, zero minutes, or any other amount of time. The telematics unit 114 may also communicate the relevant information to the OCC 108 via the dual antenna 160 and the OCC 108 may contact the vehicle owner and next user.

The telematics unit 114 and/or the OCC 108 potentially send multiple notifications to both the owner and the next user during step 408. For example, the vehicle owner and subsequent user are notified when the vehicle is 30 minutes away from the return destination, when the vehicle is 15 minutes away from the return destination, and when the vehicle has arrived at the return destination. Furthermore, the times issued during step 408 to the owner and next user may differ. For example, the times provided to the owner are actual estimated time of return and the times provided to the next user take into consideration the need to process (e.g., inspect and clean) the returned car. In yet another example time-based notification scheme, the time of return threshold-based notifications are sent to interested parties (e.g., next user) based upon calculating an estimated time of the interested party (e.g., next user) to reach the return destination. Such time includes, for example, flight information relating to the next user.

Having described several examples of using GPS signals and other vehicle data to aid management of rental/loan agreements, it is noted that the disclosed systems and methods are not limited to such uses. For example, the ability to determine an estimated time of return for a vehicle based upon a current geospatial location and turn-by-turn data relating to a calculated path to a specified destination (e.g., rental return location) can be applied to other deadlines such as flight departures. In addition to the route calculation, which may include real time condition adjustments such as bad road conditions and/or real-time accident information, the flight departure deadline-based warning includes, for example, rental return delays, transit delays from the rental location to the airplane terminal, security delays, etc. Thus, the warning to a current user of a vehicle need not be based upon the car return deadline time (based upon a scheduled next user). Instead (or in addition), the warning specified in the use agreement to enable configuration of a proper warning of non-compliance can be for the benefit of the current user to ensure that the user returns the vehicle in sufficient time to make a scheduled flight. Thus, a violation of (non-compliance with) a vehicle use agreement should be interpreted broadly herein to include both owner imposed terms (e.g., deadline to ensure availability of the vehicle for a next user) and user requested terms (e.g., flight departure times).

It will be appreciated by those of skill in the art that execution of various machine-implemented processes and steps described herein occur via the computerized execution of computer-executable instructions stored on a non-transitory/tangible computer-readable medium, e.g., RAM, ROM, PROM, volatile, nonvolatile, or other electronic memory mechanism. Thus, for example, the operations performed by the telematics unit are carried out according to stored instructions or applications installed on the telematics unit, and operation performed at the call center are carried out according to stored instructions or applications installed at the call center.

It is thus contemplated that other implementations of the invention may differ in detail from foregoing examples. As such, all references to the invention are intended to reference the particular example of the invention being discussed at that point in the description and are not intended to imply any limitation as to the scope of the invention more generally. All language of distinction and disparagement with respect to certain features is intended to indicate a lack of preference for those features, but not to exclude such from the scope of the invention entirely unless otherwise indicated.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for monitoring and aiding compliance with terms and conditions of a vehicle use agreement comprising the steps of:
receiving vehicle data from at least one of a vehicle sensor and a GPS chipset;
applying the received vehicle data to pre-stored data pertaining to terms and conditions of a vehicle use agreement;
identifying, based upon the applying step, a potential violation of the vehicle use agreement; and
issuing a notification, in response to the identifying step, of the potential violation via an in-vehicle telematics communication channel to at least one of the group consisting of:
a current driver,
a vehicle owner, and
a subsequent user.

2. The method of claim 1 wherein the applying step comprises comparing an estimated earliest time of arrival for the vehicle based upon a current vehicle location and a return time pursuant to the vehicle use agreement.

3. The method of claim 1 wherein the applying step comprises comparing a current vehicle location, as provided by the GPS chipset, to an area defined by a geospatial range or area limitation pursuant to the vehicle use agreement.

4. The method of claim 1 wherein the applying step comprises comparing a current mileage, provided via a telematics system on the multi-user vehicle, to a mileage limit specified by the vehicle use agreement.

5. The method of claim 1 wherein the vehicle use agreement is a rental agreement, and wherein terms and conditions of the vehicle use agreement stored in a database are used, during the applying step, to identify a potential violation of the vehicle use agreement.

6. A method for administering terms and conditions of a vehicle use agreement comprising:
receiving vehicle data pertaining to non-compliance, by a current user of a vehicle, with a first vehicle use agreement;
determining whether a failure, by the current user, to comply with the first vehicle use agreement creates an opportunity for a subsequent user to modify terms and conditions of a second vehicle use agreement; and
if non-compliance, by the current user, with the first use agreement creates the opportunity for modifying the second vehicle use agreement, then performing the further steps of:
notifying the subsequent user of the non-compliance and requesting the subsequent user to choose from possible modifications of the second use agreement,
receiving a response by the subsequent user indicating a modification to second vehicle use agreement, and
modifying the second vehicle use agreement pursuant to the response by the subsequent user.

7. The method of claim 6 wherein the terms and conditions of a second vehicle use agreement pertain to a reservation for a next user of the vehicle.

8. A method for monitoring and aiding timely return of a multi-user vehicle comprising:
ascertaining a current location of the multi-user vehicle from data provided by a GPS chipset on the multi-user vehicle;
ascertaining a return destination and a return time for the multi-user vehicle specified by a vehicle use agreement from pre-stored data;
first determining the expected travel time from the current location of the multi-user vehicle to the return destination;
second determining whether the soonest possible expected return time is later than a warning trigger time based, at least in part, upon the return time specified by the vehicle use agreement; and
issuing a warning if, during the second determining step, the soonest possible expected return time is later than the warning trigger time, the warning being accompanied by turn-by-turn directions from the current location to the return destination.

9. The method of claim 8, wherein determining the expected travel time from the current location of the multi-user vehicle to the return destination comprises:
determining the expected average speed on each section of the route, determining the total distance of each section of the route, calculating the expected time spent on each section of the route based on the expected average speed for each section and the total distance of each section, and summing the expected times spent on each section.

10. The method of claim 9, wherein determining the expected average speed on each section of the route is calculated from one or more of the group consisting of:
a speed limit of the section, historical data pertaining to traffic flow on the section, current traffic data on the section, and weather conditions on the section.

11. The method of claim 8, wherein issuing the warning comprises:
sending a communication to a mobile device owned by a current user of the vehicle.

12. The method of claim 8, further comprising:
offering a current user of the vehicle a choice to extend a vehicle use period specified in the vehicle use agreement and to pay a corresponding fee.

13. The method of claim 12, wherein offering the current user the choice to extend the vehicle rental period and to pay a corresponding fee comprises:
sending a communication to a mobile device owned by the current user of the vehicle.

14. The method of claim 8, further comprising:
notifying interested parties that the multi-user vehicle will be returned late; and
notifying interested parties that the multi-user vehicle has reached a location within one or more threshold estimated travel times of the return destination.

15. The method of claim 14, wherein the interested parties are one or more of the group consisting of: a vehicle owner and a next scheduled user.

16. The method of claim 14, wherein the one or more threshold travel times are determined by prompting one or more of the interested parties to choose to be notified when the multi-user vehicle is within one or more estimated travel times of the return destination.

17. The method of claim 14, wherein the one or more threshold travel times are determined by calculating an estimated travel time from a current location of an interested party to the return destination.
